(19) United States
(12) Patent Application Publication
(10) Pub. No.: US 2009/0110227 A1
(43) Pub. Date: Apr. 30, 2009

(54) Earphone earbud stabilizer

(76) Inventor: Allen Lamont Prince, Dallas, TX (US)

Correspondence Address: ALLEN L. PRINCE, 1502 OAK GLEN TRL., DALLAS, TX, 75232, US

(21) Appl. No.: 11/931,829

(22) Filed: Oct. 31, 2007

(51) Int. Cl. H04R 1/00

(52) U.S. Cl. 381/380

(57) ABSTRACT

A springy or malleable conformable wire or wirelike stabilizer structure attached to an earbud microphone or earphone that maintains maximal contact with the wall structures of the ear around the wall of the concha region of the ear and the wall under the overhang of the helix providing a secure hold within the ear preventing easy dislodgement of an earbud device without visible means of an earhook.

### BACKGROUND OF THE INVENTION

1. Field of the Invention

The present invention relates generally to a device or structure attached to or is a part of earphones and transmitters that have an earbud structure that fits inside the choncha cavity of the ear over or into the ear canal of a wearer during use that serve to secure and stabilize the earbud by securely holding the earbud in place over or into the ear canal for use in telecommunications, telephony and multimedia devices.

2. Background Art

It is becoming very common for multimedia devices to provide means for communication with tiny portable speakers and microphones that are small enough to be inserted inside the concha of the ear over the ear canal either in pairs or as a single device during use either with wires attached for communication with other devices while communication with other devices by means of radio transmissions.

The devices that fit into the ear may be custom fitted to remain securely confined within the concha of the outer ear structure by either having a custom fitted shape that conforms and fits snuggly in contact with the walls of the ear canal or the walls of the conch cavity to the ear canal. When custom fitting is not available as when universally constructed, the earbud is generally provided with a foam or conforming cover that fits over the earbud to approximate a custom fit for the average ear structures. Alternatively, an earbud is provided with an attached earhook that fits over or around the outer ear between the head of the user and the outer structures of the ear connecting to the outer opening of the concha and the helix of the ear just outside and exterior to the walls of the concha cavity as means for securing the earbud inside the concha cavity.

A great amount variation exists among the ear shapes of different people in general that must be accommodated when designing a universal fit for earbud structures. The tragus and anti-tragus are structures that extend over the ear canal and generally serve to overhang a portion of the earbud structure which helps prevent the earbud from becoming dislodged and falling out of the ear. Foam covers for ear buds generally allow the earbud to obtain greater contact with the walls of the concha inside the concha between the ear canal and the overhanging tragus and anti-tragus to hold the earbud by means of friction with the concha walls.

Some custom fit earbud attachments are designed to fill the entire concha cavity to maximize security by maintaining contact with all the concha walls by including the walls above and behind the concha cavity but are unattractive and not suited for providing a universal fit due to variations in concha shapes among individuals. Earhooks are also unattractive and interfere with earpieces of eyeglasses by competing for space between the top of the ear and the side of the wearer's head. The earbud can be secured by attaching a structure the fits over the head which is cumbersome.

### SUMMARY OF THE INVENTION

The present invention is a stabilizing extension structure with means for attachment to or is a part the structure of an earbud microphone when the earbud is inserted within the concha cavity of the ear over the ear canal. When worn during microphone use the extension structure provides means for maximizing use and contact with the natural structures of the ear and the stabilizing structure attached to or a part of the earbud to prevent the earbud from being dislodged from the ear. More specifically, the invention extends contact of the earbud and its stabilizing structure to maintain contact with and against the back, upper and forward wall of the concha and beneath the inner fold of the helix at the front and top of the ear.

### BRIEF DESCRIPTION OF THE DRAWINGS

The present invention will b e described with reference to the accompanying drawings wherein like reference numerals identify corresponding or like components.

FIG. 1 is a side view of the ear showing an embodiment of the present invention while being worn in the ear of a wearer that provides maximal contact with the ear wall structures by extending out and over the helix floor under the overhanging helix.

FIG. 2 is a side view of the ear showing an embodiment partly inserted in the ear with the upper region of the embodiment not yet installed against the upper wall of the concha or under the fold of the front and upper region of the helix.

FIG. 3 is a side view of the ear showing an embodiment of the present invention being worn in the ear of a wearer that provides less than maximal contact with the ear wall structures by not extending out and over the helix floor with the tip optionally extending forward against the concha wall under the helix overhang and against the helix wall.

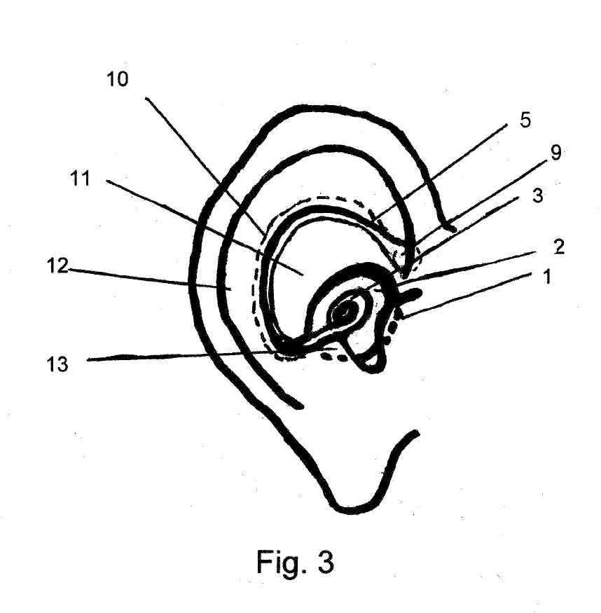

### DETAILED DESCRIPTION OF THE DRAWINGS

There are basically two surfaces of each ear that are approximately parallel to the side of the head comprising the normal outer ear structures that exist at two levels with respect to the side of the head. The outermost level or surface, herein referred to as the floor of the helix, is surrounded in front, along the top and along the back edges of the ear by the helix 7 extending somewhat under the inner edges 8 of the helix forming a helix wall 8 that is largely hidden by the outer surfaces helix.

The innermost level or surface of the normal outer ear, herein referred to as the floor of the concha 11, is surrounded along the top and back by the helix floor which overhangs the floor of the concha 12 hiding the walls of the concha connecting the floor of the concha to the overhanging helix. Along the bottom of the floor of the concha near the front of the ear structure of the concha exists the ear canal that enters into the side of the head just under the tragus 1 in front and the anti-tragus 13 behind, each overhanging a portion of the ear canal.

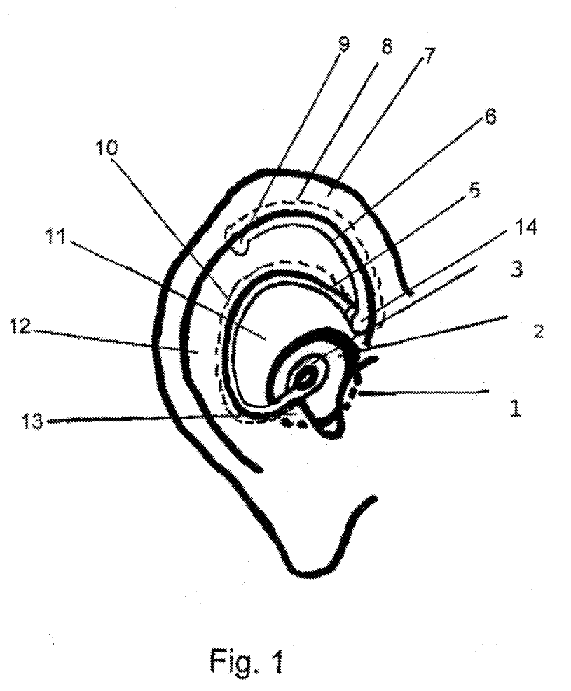

FIG. 1 illustrates the preferred embodiment of the invention as it is used to hold an earbud earphone device 2 against the walls of the concha over the ear canal against the regions of the wall of the concha that exists below the tragus and the anti-tragus.

The preferred embodiment is a tubular or wire stabilizing structure, the stabilizer, with two ends, one of which comprises a means for attaching to an earbud type microphone device and the other terminating with a soft or smooth nonirritating tip 9, shaped such that all along the extent of the stabilizer when worn remains in contact with some surface of the ear as hereinafter described.

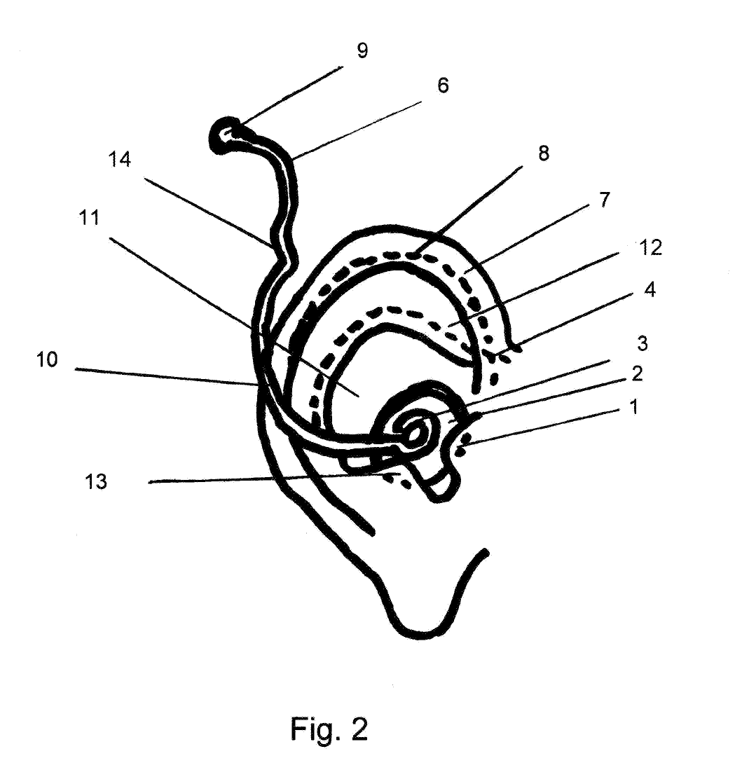

FIG. 2 illustrates the preferred embodiment of the stabilizer comprised of a flexible spring that can be bent to fit against walls of the ear structure as depicted in FIG. 1. The embodiment illustrated depicts a body 10 that extends from a point of attachment with the earbud microphone at one terminus and the embodiment continues to form a riser 4 and from the riser and continues as a neck 6 and terminates at the tip. The flexible spring stabilizer is just springy enough to allow, with a light amount of force downward while the earbud is in place over the ear canal, the body to be bent to fit against the walls of the surfaces as depicted in FIG. 1 such that the overhanging ear structures as depicted in FIG. 2 hold the spring in place against the walls along the entire length of the stabilizer.

Another embodiment is a rigid but flexible structure that can adjusted to fit and hold hits shape, as depicted in FIG. 1, for ears that are sensitive to the pressures applied by the springy embodiment. The spring is shaped to self adjust while the fixed shape can be adjusted, each to maintain contact against and along the wall next to the floor of the concha 8, shown partially hidden by the overhanging floor of the helix, maximizing contact by optionally extending the stabilizer outward as a riser 4 shown partially hidden under the overhanging helix, extending the device outward to the level of the floor of the helix where the neck 6 of the embodiment extends upward and around toward the back against the wall of the floor of the helix 8 just under the overhang of the helix shown partially hidden by the body of the helix 7 terminating by a soft tip 9 of the embodiment also shown partially hidden under the overhanging helix.

FIG. 2 illustrates the preferred embodiment with the earbud 2 inserted over the ear canal held in place by the overhanging tragus 1 and anti-tragus 13. A means for attachment of the stabilizer structure to the earbud is a ring at the earbud attachment that clamps onto or around a neck on the outer surface of the earbud. If there is no neck on the earbud, the means for attachment may be a cup with two connected openings, one opening into the ear canal and the other into which an earbud may be inserted and held in place over the connected openings opening into ear canal. A temporary means for attachment may be provided in the form of a clip or clamp as required for any of various shapes of earbud earphones or microphones.

What is claimed is:

1. An earphone earbud stabilizer that is a continuous wirelike structure comprised of a body and first and second ends, the first end comprised of means for attachment to an earbud type microphone or earphone worn by a user over the ear canal of an ear of the user under the overhanging tragus and anti-tragus of the ear such that the stabilizer body region fits in contact along its extent with the wall of the concha under the overhanging floor of the helix such as to maintain maximal contact with the proximate ear structures and to prevent the earbud from easily falling out of position during use from its intended location over the ear canal.

2. The earphone earbud stabilizer as in claim 1 wherein the second end of the stabilizer body is extended to form a riser, a neck region and second end wherein the riser is a bend outward to the level of the helix floor and continues as a neck region that fits in continuous contact along the wall of the helix floor under the overhanging helix structure of the ear such as to maintain maximal contact with the proximate ear structures and to further prevent the earbud from easily falling out of position during use from its intended location over the ear canal.

3. The stabilizer structure in claims 1 or 2 wherein the earbud and the stabilizer are constructed as a single integrated device.
